(19) United States
(12) Patent Application Publication
(10) Pub. No.: US 2025/0367943 A1
(43) Pub. Date: Dec. 4, 2025

(54) PRINTING DEVICE READING SURFACE OF PRINTING TARGET ON PLATEN TO OBTAIN SCAN DATA

(71) Applicant: BROTHER KOGYO KABUSHIKI KAISHA, Nagoya (JP)

(72) Inventor: Hiroto TAKAHASHI, Nagoya (JP)

(21) Appl. No.: 19/189,825

(22) Filed: Apr. 25, 2025

(30) Foreign Application Priority Data
May 31, 2024 (JP) 2024-088695

(51) Int. Cl. B41J 3/44; B41J 11/06; B41J 11/14; B41J 29/00; H04N 1/00; H04N 1/028

(52) U.S. Cl. CPC B41J 3/44; B41J 11/06; B41J 11/14; B41J 29/00; H04N 1/00037; H04N 1/00074; H04N 1/028

(57) ABSTRACT

In a printing device, a reader is positioned upstream of a print head in a first moving direction. The controller includes one or more processors. The controller performs a first reading process including moving, by controlling a platen moving member, the platen in the first moving direction, and reading, by controlling the reader, a surface of a printing target on the platen to obtain first scan data. The controller performs a printing process after starting the first reading process. The printing process includes printing, by controlling the print head, an image on the surface of the printing target on the platen. The controller performs a second reading process including moving, by controlling the platen moving member, the platen in a second moving direction opposite the first moving direction, and reading, by controlling the reader, the image on the surface of the printing target to obtain second scan data.

### REFERENCE TO RELATED APPLICATIONS

This application claims priority from Japanese Patent Application No. 2024-088695 filed on May 31, 2024. The entire content of the priority application is incorporated herein by reference.

### BACKGROUND ART

A known printing device includes nozzles that eject ink, a platen that supports a medium, an optical sensor capable of detecting colors, and a controller. Contact image sensors (CIS) and charge-coupled devices (CCD) are examples of possible optical sensors. The controller prints detection patterns on the medium supported on the platen and determines whether a defective ejection occurred from any of the nozzles based on detection results of the detection patterns obtained from the optical sensor.

### SUMMARY

Although the known printing device described above addresses some problems attributed to the printing device (i.e., the nozzle ejection defects), the known device cannot address the other problems.

In view of the foregoing, it is an object of the present disclosure to provide a printing device that contributes to the detection of various problems.

In order to attain the above and other objects, the present disclosure provides a printing device. The printing device includes a platen, a print head, a reader, a platen moving member, and a controller. The reader is positioned upstream of the print head in a first moving direction. The controller includes one or more processors. The controller is configured to perform: a first reading process including: moving, by controlling the platen moving member, the platen in the first moving direction; and reading, by controlling the reader, a surface of a printing target on the platen to obtain first scan data; a printing process after starting the first reading process, the printing process including: printing, by controlling the print head, an image on the surface of the printing target on the platen; and a second reading process including: moving, by controlling the platen moving member, the platen in a second moving direction opposite the first moving direction; and reading, by controlling the reader, the image on the surface of the printing target on the platen to obtain second scan data.

In order to attain the above and other objects, the present disclosure further provides a printing device. The printing device includes a platen, a print head, a reader, a platen moving member, and a controller. The reader is positioned upstream of the print head in a first moving direction. The controller includes one or more processors. The controller is configured to perform: a first reading process including: moving, by controlling the platen moving member, the platen in the first moving direction; and reading, by controlling the reader, a surface of a printing target on the platen to obtain first scan data; a printing process after starting the first reading process, the printing process including: printing, by controlling the print head, an image on the surface of the printing target on the platen; and a first information providing process after completing the first reading process, the first information providing process including: providing information based on the first scan data.

In order to attain the above and other objects, the present disclosure further provides a printing device. The printing device includes a platen, a print head, a reader, a platen moving member, and a controller. The reader is positioned upstream of the print head in a first moving direction. The controller includes one or more processors. The controller is configured to perform: a first reading process including: moving, by controlling the platen moving member, the platen in the first moving direction; and reading, by controlling the reader, a surface of a printing target on the platen to obtain first scan data; a printing process after starting the first reading process, the printing process including: printing, by controlling the print head, an image on the surface of the printing target on the platen; and a first determining process including: determining, based on the first scan data, whether the surface has a defect.

In the above structures, the first scan data obtained by the printing device helps to detect defects other than defects caused by the print head, such as the nozzle ejection defects.

### BRIEF DESCRIPTION OF DRAWINGS

FIG. 1 is a perspective view of a printing device.

FIG. 2A is a schematic left side view of the printing device when a platen is in a mounting/removing position, and a reader is in a post-print reading position.

FIG. 2B is a schematic left side view of the printing device when the platen is in a reading position, and the reader is in a proximity position.

FIG. 2C is a schematic left side view of the printing device when the platen is in a reversing position, and the reader is in a post-print reading position.

FIG. 2D is a schematic left side view of the printing device when the platen is in a printing position, and the reader is in the post-print reading position.

FIG. 3 is a block diagram illustrating an electrical configuration of the printing device.

FIG. 4 is a diagram illustrating an overview of a main process.

FIG. 5 is a flowchart illustrating the main process.

### DESCRIPTION

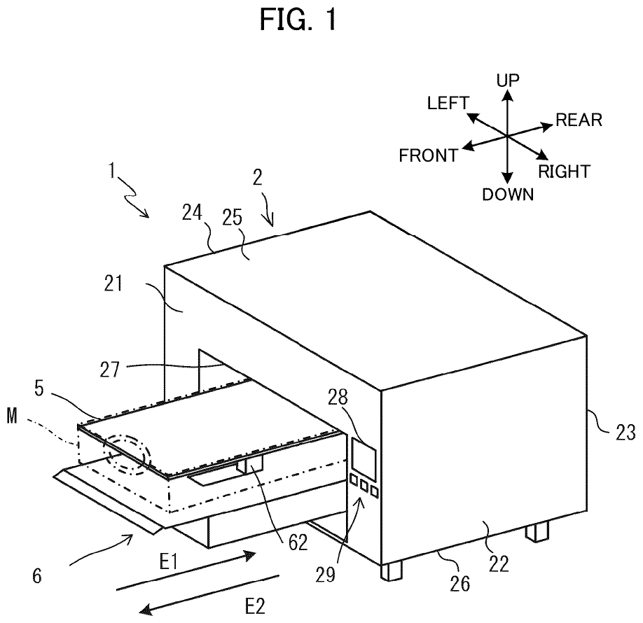

A printing device 1 according to one embodiment of the present disclosure will be described while referring to the accompanying drawings. The top, bottom, lower-left, upper-right, lower-right, and upper-left of FIG. 1 will denote the top, bottom, front, rear, right, and left of the printing device 1 in the following description. The left-right direction of the printing device 1 is referred to as a main scanning direction, and the front-rear direction is referred to as a sub-scanning direction.

The overall configuration of the printing device 1 will be described with reference to FIGS. 1 through 3. As shown in FIG. 1, the printing device 1 includes an enclosure 2, a platen moving member 6, and a platen 5.

The enclosure 2 has a front wall 21, a right wall 22, a rear wall 23, a left wall 24, a top wall 25, and a bottom wall 26 defining a rectangular parallelepiped that is elongated in the left-right direction. An opening 27 is formed in the front wall 21 of the enclosure 2. Specifically, the opening 27 extends from the front wall 21 to the rear wall 23 of the enclosure 2 in such a manner that the opening 27 extends through the enclosure 2 in the front-rear direction. A display 28 and an input interface 29 are located on the front wall 21 of the enclosure 2 to the right of the opening 27. The display 28 is a liquid crystal display that displays images. The input interface 29 includes a plurality of buttons located on the front wall 21 of the enclosure 2 below the display 28. The user of the printing device 1 inputs various information into the printing device 1 through operation using the input interface 29.

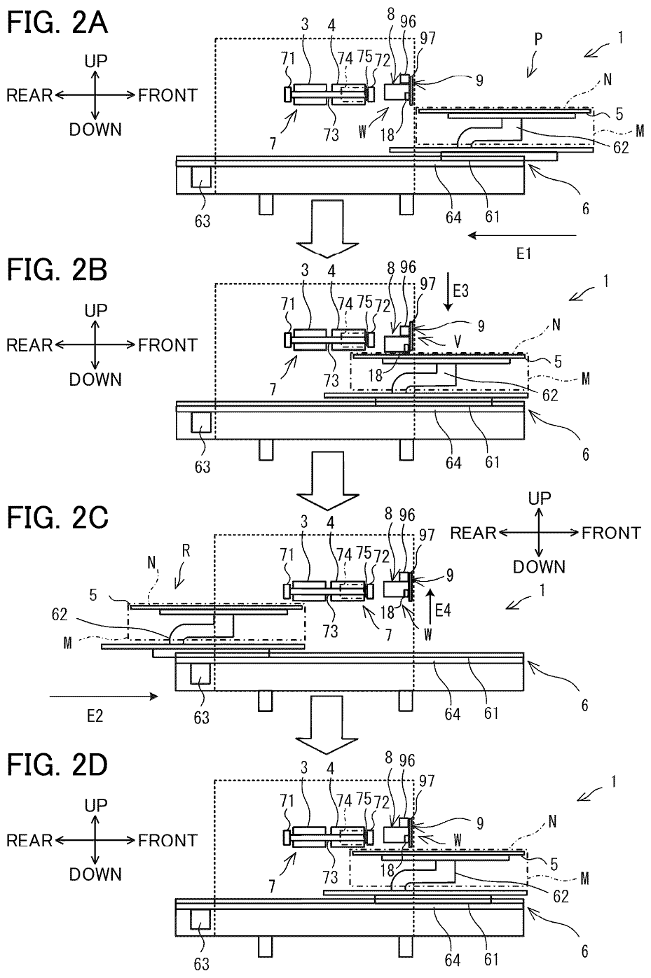

The platen moving member 6 has a rectangular parallelepiped shape. In a side view, the platen moving member 6 is rectangular and elongated in the front-rear direction. The platen moving member 6 is inserted into the opening 27. The front end of the platen moving member 6 is positioned farther forward than the front wall 21 of the enclosure 2, and the rear end of the platen moving member 6 is positioned farther rearward than the rear wall 23 of the enclosure 2. As shown in FIGS. 2A through 2D, the platen moving member 6 includes rails 61, a platen support member 62, a sub-scanning motor 63, and a transmission mechanism 64. The rails 61 extend in the front-rear direction. The platen support member 62 is positioned at the top of the platen moving member 6 and is supported by the rails 61. The sub-scanning motor 63 is a pulse motor capable of forward and reverse rotation, for example. The transmission mechanism 64 is a drive belt connected to the sub-scanning motor 63 and the platen support member 62. The transmission mechanism 64 transmits the drive force of the sub-scanning motor 63 to the platen support member 62 in order to move the platen support member 62 along the rails 61 in a sub-scanning direction (i.e., the front-rear direction). The platen support member 62 is moved between a mounting/removing position P shown in FIG. 2A and a reversing position (turning position) R shown in FIG. 2C.

As shown in FIG. 2A, the mounting/removing position P is the position of the platen 5 at which a medium M can be removed from or mounted on the platen 5. The medium is an example of the printing target. The mounting/removing position P is the position of the platen 5 before the printing device 1 starts printing or after the printing device 1 completes printing. The mounting/removing position P shown in FIG. 2A is the forwardmost point in the range of movement of the platen 5 and constitutes both the start point and end point along the conveying path of the platen 5. The reversing position R shown in FIG. 2C is the rearwardmost point in the range of movement of the platen 5 and a midpoint along the conveying path of the platen 5.

As shown in FIG. 1, the platen 5 has a rectangular plate shape in a plan view and extends in horizontal directions. The platen 5 is mounted on the platen support member 62 from above and remains supported on the platen support member 62 while its vertical position relative to the platen support member 62 is adjusted. The medium M is placed on the top surface of the platen 5. The medium M is a fabric garment, such as a T-shirt. When the platen support member 62 is moved in the front-rear direction, the platen 5 and the medium M supported on the platen 5 also move in the front-rear direction.

As shown in FIGS. 2A through 2D, the printing device 1 has a main scanning drive member 7, print heads 3 and 4, a reader (reading assembly, reading sensor) 8, a contact sensor 18, and a reader moving member 9 disposed inside the enclosure 2.

The main scanning drive member 7 includes a rail 71, a guide shaft 72, a carriage 73, a main scanning motor 74, and a transmission mechanism 75. The rail 71 extends in the left-right direction of the printing device 1. The guide shaft 72 is disposed on the front of the rail 71 and extends in the left-right direction. The carriage 73 is positioned between the rail 71 and the guide shaft 72 in the front-rear direction and is supported by the rail 71 and guide shaft 72. The main scanning motor 74 is disposed to the right of the right end portion of the guide shaft 72. The transmission mechanism 75 is a drive belt connected to the main scanning motor 74 and the carriage 73, for example, and transmits the drive force of the main scanning motor 74 to the carriage 73 in order to move the carriage 73 in the main scanning direction (i.e., the left-right direction) along the rail 71 and guide shaft 72.

The print heads 3 and 4 are inkjet heads located in the carriage 73. The print head 3 is located in the rear portion of the carriage 73 and ejects white ink downward. The print head 4 is located in front of the print head 3, and ejects color ink downward. The white ink is used for printing in areas of images to be rendered in white, or used as a base or ground for the color ink. Color ink is ejected directly onto a target surface N of the medium M or on top of a white ink base and is used to print color images. The target surface N is a surface of the medium M The color ink includes four ink colors, such as black, cyan, yellow, and magenta. The print heads 3 and 4 move together with the carriage 73 in the left-right direction. The target surface N in this embodiment is the top surface of the medium M.

The reader 8 is configured to read the target surface N on the medium M. In the present embodiment, the reader 8 is a contact image sensor and, while not shown in the drawings, includes a light source, a light-receiving element, and a contact glass. The light source irradiates light onto the medium M. The light source has a plurality of LEDs arranged in a line extending in the sub-scanning direction, for example. The light-receiving element receives light reflected off the medium M. The light-receiving element includes a plurality of CMOS sensors arranged in a line, for example. The light source irradiates light onto the medium M through the contact glass, and the light-receiving element receives the reflected light from the medium M and converts the image information to scan data. When the reader 8 of this embodiment is arranged in a proximity position close to the target surface N, the target surface N falls within the depth of field of the reader 8 in the direction orthogonal to the platen 5 and, hence, is in focus. The proximity position is a position within a distance of 10 mm from the target surface N. In this embodiment, the proximity position is the position when the reader 8 contacts the target surface N. The contact sensor 18 mechanically detects when the reader 8 is in contact with the target surface N of the medium M.

The reader moving member 9 is configured to move the reader 8 in an approaching direction E3 (see FIG. 2B) for approaching the platen 5 and in a separating direction E4 opposite the approaching direction E3 (see FIG. 2C). The approaching direction E3 in this embodiment is downward, which is the same as the direction ink is ejected from the print heads 3 and 4, while the separating direction E4 is upward. The reader moving member 9 includes a drive motor 96, and a transmission mechanism 97. The transmission mechanism 97 is a pinion and rack coupled to the drive motor 96, for example. The drive of the drive motor 96 moves the reader 8 in the approaching direction E3 and separating direction E4 between a post-print reading position W shown in FIG. 2A and a proximity position V shown in FIG. 2B. The proximity position V is located farther in the approaching direction E3 than the post-print reading position W and is set according to the thickness of the medium M placed on the platen 5. The post-print reading position W may be the same position regardless of the thickness of the medium M or may be set according to the proximity position V.

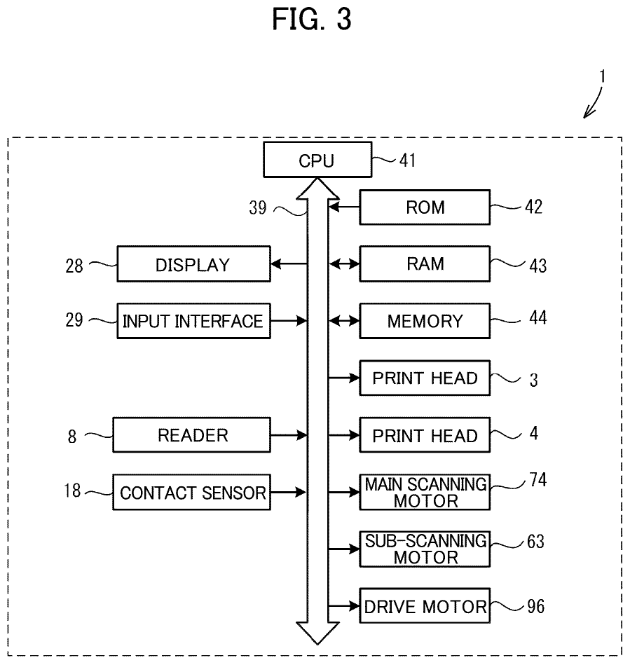

Next, the electrical configuration of the printing device 1 will be described with reference to FIG. 3. The printing device 1 includes a CPU 41, a ROM 42, a RAM 43, and a memory 44. The CPU 41 performs control of the printing device 1 and is electrically connected to the ROM 42, RAM 43, and memory 44 via a signal line 39. The ROM 42 stores a printing device control program described later for instructing the CPU 41 in controlling the operations of the printing device 1, and information used by the CPU 41 when executing various programs. The ROM 42 stores associations between rotated angles of the sub-scanning motor 63 and corresponding positions of the platen 5 in the sub-scanning direction. The RAM 43 temporarily stores various data used in the programs. The memory 44 is nonvolatile memory and stores print data for printing. The print data may be generated by the printing device 1 and stored in the memory 44 or may be obtained from an external device and stored in the memory 44. External devices are devices other than the printing device 1, such as personal computers (PCs) and smartphones.

The CPU 41 is also electrically connected to the main scanning motor 74, sub-scanning motor 63, drive motor 96, print heads 3 and 4, display 28, input interface 29, reader 8, and contact sensor 18 via the signal line 39. The main scanning motor 74, sub-scanning motor 63, drive motor 96, and print heads 3 and 4 are all driven under control of the CPU 41.

The input interface 29 outputs various information to the CPU 41. By operating the input interface 29, the user of the printing device 1 can input various information into the printing device 1, including the platen size and a print instruction to start a print on the printing device 1. The reader 8 reads images in response to an instruction from the CPU 41 or from the user and outputs the resulting scan data to the CPU 41. The contact sensor 18 outputs detection results to the CPU 41 indicating whether the reader 8 has contacted the target surface N of the medium M.

According to the above configuration, the printing device 1 moves the platen 5 in the sub-scanning direction in order to convey the medium M on the platen 5 in the front-rear direction relative to the print heads 3 and 4. The printing device 1 also moves the carriage 73 in the main scanning direction in order to move the print heads 3 and 4 in the left-right direction relative to the medium M on the platen 5. The printing device 1 ejects ink from the print heads 3 and 4 onto the medium M carried on the platen 5 to print an image on the medium M.

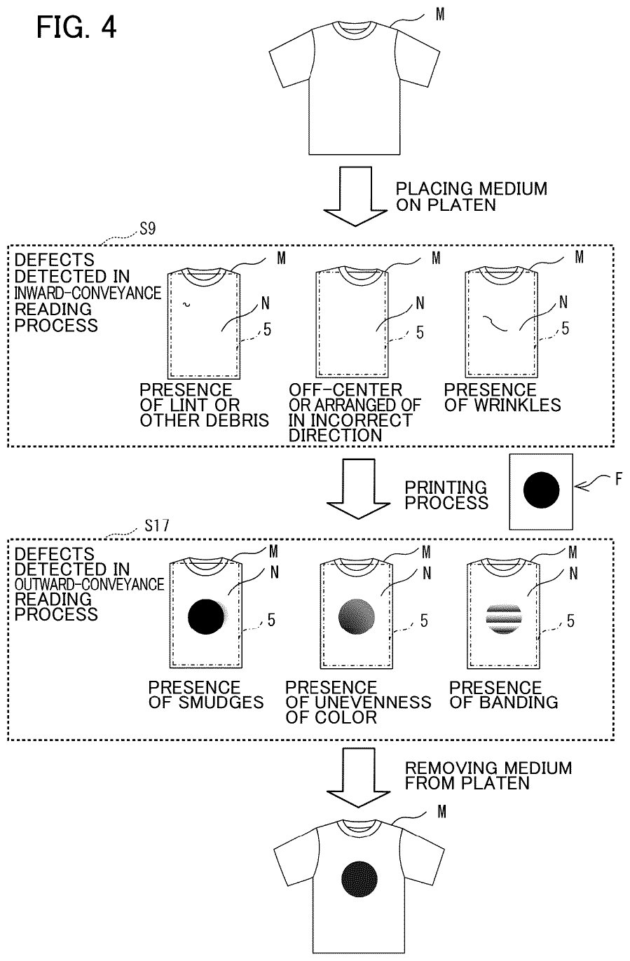

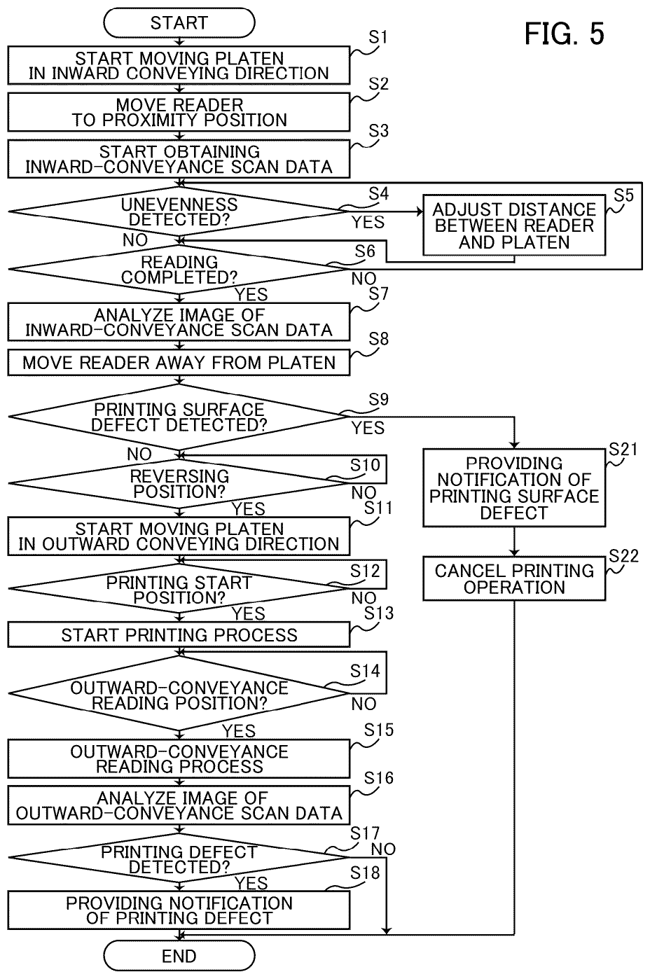

Next, a main process will be described with reference to FIGS. 4 and 5. When the power to the printing device 1 is turned on and the user inputs a print instruction, the CPU 41 reads the printing device control program from the ROM 42 and performs operations in accordance with the control program to execute the main process. The printing device control program includes instructions directing the CPU 41 to execute the following process. The main process includes operations to detect defects in the target surface N of the unprinted medium M placed on the platen 5, to convey the platen 5, to control printing, and to detect printing defects. The memory 44 stores various parameters for use in executing the main process. Various data obtained during the course of the main process is stored in the RAM 43. Steps in the following description are abbreviated as “S”. At the start of the main process, the platen 5 is in the mounting/removing position P shown in FIG. 2A and the medium M has been placed on the platen 5. The reader 8 is disposed in the post-print reading position W at the start of the main process. The following description covers a specific case of printing the medium M shown in FIG. 4 based on print data F.

In S1 at the beginning of the main process shown in FIG. 5, the CPU 41 starts a process of driving the sub-scanning motor 63 to convey the platen 5 in an inward conveying direction E1. Through the process of S1, the platen 5 moves in the inward conveying direction E1, i.e., rearward, from the mounting/removing position P shown in FIG. 2A. In S2 the CPU 41 executes an approaching process to bring the reader 8 close to the target surface N by driving the drive motor 96 for moving the reader 8 in the approaching direction E3. In the approaching process, the CPU 41 moves the reader 8 in the approaching direction E3 to the proximity position V based on detection results from the contact sensor 18.

In S3 the CPU 41 starts an inward-conveyance reading process for obtaining inward-conveyance scan data using the reader 8 to read the target surface N of the unprinted medium M supported on the platen 5, which is being moved in the inward conveying direction E1 by the platen moving member 6. The inward-conveyance scan data is scan data obtained in the inward-conveyance reading process. In the present embodiment, the CPU 41 performs the inward-conveyance reading process following the approaching process of S2 while the reader 8 is in contact with the target surface N. Unlike when executing an outward-conveyance reading process described later, the reader 8 has been moved farther in the approaching direction E3 by the reader moving member 9 when the CPU 41 executes the inward-conveyance reading process. The CPU 41 performs the inward-conveyance reading process to control the reader 8 to read the target surface N in combination with controlling the sub-scanning motor 63 to convey the platen 5 in the inward conveying direction E1. Here, reading the target surface N with the reader 8 and conveying the platen 5 in the inward conveying direction E1 may be performed simultaneously, partially overlapping in time, or alternately. In S4 the CPU 41 determines whether unevenness has been detected on the target surface N based on the detection results from the contact sensor 18. When the medium M is a garment such as a T-shirt, unevenness in the printing surface may be detected along pockets, and the neckline. Since the proximity position V in the present embodiment is the position at which the reader 8 contacts the target surface N, the CPU 41 maintains the reader 8 in contact with the target surface N by moving the reader 8 in the direction orthogonal to the platen 5 (i.e., the up-down direction) in correspondence with the unevenness in the target surface N. That is, the CPU 41 maintains the reader 8 in contact with the target surface N based on detection results outputted from the contact sensor 18.

When unevenness has been detected (S4: YES), in S5 the CPU 41 drives the drive motor 96 to adjust the distance in the approaching direction E3 between the platen 5 and the reader 8 with the reader moving member 9 during the execution period for the inward-conveyance reading process. Here, the execution period for the inward-conveyance reading process denotes the period from the start of the inward-conveyance reading process (S3) to the completion of the inward-conveyance reading process (S6: YES). In this embodiment, the CPU 41 modifies the distance between the platen 5 and the reader 8 in S5 at a timing during the execution period of the inward-conveyance reading process that reading is not being performed by the reader 8. Through the process of S5, the CPU 41 moves the reader 8 in either the approaching direction E3 or the separating direction E4 to maintain the reader 8 in contact with the target surface N. After completing the process to move the reader 8 in S5 or when no unevenness was detected (S4: NO), in S6 the CPU 41 determines whether the reader 8 has finished reading the target surface N. The CPU 41 determines in S6 whether reading of the target surface N has been completed based on the position of the platen 5 in the sub-scanning direction, for example. When reading has not been completed (S6: NO), the CPU 41 returns to S4.

Once reading has been completed (S6: YES), in S7 the CPU 41 performs image analysis of the inward-conveyance scan data in order to detect defects in the target surface N of the medium M supported on the platen 5. The types and number of types of printing surface defects to be detected may be set as appropriate. When analyzing images based on the inward-conveyance scan data in the present embodiment, the CPU 41 detects printing surface defects from the three perspectives illustrated in FIG. 4: whether any lint or other debris is present on the target surface N, whether the medium M is off-center or arranged in an incorrect direction, and whether any wrinkles are present. The CPU 41 determines whether wrinkles or lint or other debris are present based on whether an unexpected pattern such as a line segment has been detected. The CPU 41 determines whether the medium M is positioned off-center by detecting an area around the neckline of the medium M and determining whether the position of the detected area in the left-right direction is shifted relative to a reference. For example, the CPU 41 determines whether the medium M is positioned off-center by determining whether the center position of the detected area in the left-right direction is shifted relative to the reference. Or, the CPU 41 may determine whether the medium M is positioned off-center by determining whether the left and right ends of the detected area are shifted relative to corresponding references. The CPU 41 determines whether the medium M has been arranged in an incorrect direction based on the orientation of the fabric grain (or, weave pattern or woven texture) in the medium M, for example.

Following the inward-conveyance reading process, in S8 the CPU 41 performs a separating process by driving the drive motor 96 to move the reader 8 in the separating direction E4 opposite the approaching direction E3. Through the process of S8, the reader 8 is moved from the proximity position V to the post-print reading position W.

In S9 the CPU 41 performs an inward-conveyance defect detection process to detect one or more printing surface defects based on the results of the image analysis performed in S7 on the inward-conveyance scan data. When one or more printing surface defects have been detected (S9: YES), in S21 the CPU 41 performs an inward-conveyance notification process to report these printing surface defects. In the present embodiment, the CPU 41 displays a message on the display 28 in S21 notifying the user of the printing surface defects. The CPU 41 may report specific details of the printing surface defects in S21. The specific details may be information on types of the printing surface defects. In S22 the CPU 41 cancels the printing operation and drives the sub-scanning motor 63 to place the platen 5 in the mounting/removing position P. This concludes the main process.

When no printing surface defects were detected based on the results of image analysis in S7 (S9: NO), in S10 the CPU 41 determines whether the platen 5 has arrived at the reversing position R shown in FIG. 2C. When the platen 5 has not yet reached the reversing position R (S10: NO), the CPU 41 continues moving the platen 5 in the inward conveying direction E1 and returns to S10. Once the platen 5 has arrived at the reversing position R (S10: YES), in S11 the CPU 41 reverses the rotating direction of the sub-scanning motor 63 to start moving the platen 5 in an outward conveying direction E2. When the platen 5 is at the reversing position R, the printing target area on the target surface N of the medium M is located in the inward conveying direction E1 from (i.e., rearward of) the print heads 3 and 4. In S12 the CPU 41 starts moving the platen 5 in the outward conveying direction E2 from the reversing position R while determining whether the platen 5 has reached the printing start position. The printing start position is the position of the platen 5 when the front end of the printing target area is beneath the print head 3. While the platen 5 has not reached the printing start position (S12: NO), the CPU 41 returns to S12. Once the platen 5 has arrived at the printing start position (S12: YES), in S13 the CPU 41 starts a printing process using the print heads 3 and 4 to print an image on the target surface N of the medium M supported on the platen 5. Here, the CPU 41 prints an image according to the print data F included in the printing instruction. The CPU 41 performs the printing process in combination with controlling the sub-scanning motor 63 to convey the platen 5 in the outward conveying direction E2. Here, printing the image and conveying the platen 5 in the outward conveying direction E2 may be performed simultaneously, partially overlapping in time, or alternately.

In S14 the CPU 41 determines whether the platen 5 has arrived at an outward-conveyance reading position. The outward-conveyance reading position is the position of the platen 5 when the front end of the platen 5 is located beneath the reader 8. While the platen 5 is not yet arrived at the outward-conveyance reading position (S14: NO), the CPU 41 repeats S14. Once the platen 5 has reached the outward-conveyance reading position (S14: YES), in S15 the CPU 41 performs an outward-conveyance reading process to obtain outward-conveyance scan data using the reader 8 to read the target surface N on the printed medium M supported on the platen 5, which is being moved in the outward conveying direction E2 by the platen moving member 6. Outward-conveyance scan data is the scan data obtained in the outward-conveyance reading process. The process of S15 may be executed in parallel with the printing process or after the printing process is completed. In this embodiment, the CPU 41 executes the outward-conveyance reading process after executing the separating process of S8 so that the reader 8 is in the post-print reading position W. The CPU 41 performs the outward-conveyance reading process to control the reader 8 to read the target surface N of the printed medium M (the printed image) in combination with controlling the sub-scanning motor 63 to convey the platen 5 in the outward conveying direction E2. Here, reading the target surface N of the printed medium (printed image) with the reader 8 and conveying the platen 5 in the outward conveying direction E2 may be performed simultaneously, partially overlapping in time, or alternately.

In S16 the CPU 41 performs image analysis of the outward-conveyance scan data obtained in S15 to detect any printing defects (i.e., defects in the printed image). The types and number of types of printing defects to be detected may be set as appropriate. In the present embodiment, the CPU 41 analyzes images in the outward-conveyance scan data to detect whether any printing defects occurred during the printing process initiated in S13 from the following three perspectives illustrated in FIG. 4: whether any smudges (such as ink bleeding and slight blurring around edges of the images) present on the target surface N, whether any unevenness of colors is present, and whether banding occurred. The CPU 41 may determine whether any printing defects have occurred by comparing the outward-conveyance scan data to the image data represented by the print data, for example.

In S17 the CPU 41 performs an outward-conveyance defect detection process to detect one or more printing defects based on the results of analysis in S16 on the outward-conveyance scan data. When printing defects have been detected (S17: YES), in S18 the CPU 41 performs an outward-conveyance notification process to report the printing defects detected in the outward-conveyance defect detection process. In the present embodiment, the CPU 41 displays a message on the display 28 in S18 notifying the user of the printing defects. The CPU 41 may report specific details of the printing defects in S18. The specific details of the printing defects may be information on the types of printing defects. Following the process of S18 or when no printing defects have been detected (S17: NO), the CPU 41 moves the platen 5 to the mounting/removing position P shown in FIG. 2A. This concludes the main process.

The printing device 1, platen 5, platen moving member 6, reader 8, reader moving member 9, contact sensor 18, display 28, and CPU 41 are respectively examples of the printing device, the platen, platen moving member, reader, reader moving member, contact sensor, reporting member, and one or more processors. The print heads 3 and 4 are examples of the print head. The inward conveying direction E1 and outward conveying direction E2, approaching direction E3, and separating direction E4 are respectively examples of the first moving direction, second moving direction, third moving direction, and fourth moving direction. The medium M, target surface N, proximity position V are respectively examples of the print target, surface, approaching position. The process of S2 is an example of the approaching process. The process of S3 is an example of the first reading process. The process of S9 is an example of the process of determining a presence of a defect of the surface. The process of S13 is an example of the printing process. The process of S15 is an example of the second reading process. The process of S15 is an example of the process of determining a presence of a defect of the image. The process of S18 is an example of the second notification process. The process of S21 is an example of the first notification process.

The printing device 1 of the above embodiment includes the platen 5, the print heads 3 and 4, the reader 8, the platen moving member 6, and the CPU 41. The print heads 3 and 4 are configured to print an image on the target surface N of the medium M placed on the platen 5. The reader 8 is configured to read the target surface N on the medium M. The platen moving member 6 is configured to move the platen 5 in each of the inward conveying direction E1 and the outward conveying direction E2 opposite the inward conveying direction E1. The reader 8 is positioned upstream of the print heads 3 and 4 in the inward conveying direction E1. The CPU 41 performs the inward-conveyance reading process (S3) to obtain inward-conveyance scan data using the reader 8 to read the target surface N of the unprinted medium M supported on the platen 5, which is moved in the inward conveying direction E1 by the platen moving member 6. After executing the outward-conveyance reading process of S11, the CPU 41 performs a printing process (S13) to print images with the print heads 3 and 4 on the target surface N of the medium M supported on the platen 5. The CPU 41 performs an outward-conveyance reading process (S15) to obtain outward-conveyance scan data using the reader 8 to read the target surface N on the printed medium M supported on the platen 5, which is moved in the outward conveying direction E2 by the platen moving member 6. The CPU 41 of the printing device 1 obtains both inward-conveyance scan data from reading the target surface N on the unprinted medium M, and outward-conveyance scan data from reading the target surface N on the printed medium M. The inward-conveyance scan data obtained by the printing device 1 helps to detect defects different from nozzle ejection defects. The process of S8 is an example of the receding process.

The printing device 1 includes the reader moving member 9, which is configured to move the reader 8 in the approaching direction E3 for approaching the platen 5 and in the separating direction E4, opposite the approaching direction E3. The CPU 41 executes the inward-conveyance reading process (S2, S3) with the reader 8 being moved farther in the approaching direction E3 by the reader moving member 9 than the position of the reader 8 during an outward-conveyance reading process. The CPU 41 of the printing device 1 contributes to executing the inward-conveyance reading process with the reader 8 positioned near the platen 5, i.e., with the reader 8 having been moved by the reader moving member 9 farther in the approaching direction E3 than the position of the reader 8 during the outward-conveyance reading process.

The printing device 1 includes the reader moving member 9, which is configured to move the reader 8 in the approaching direction E3 for approaching the platen 5 and in the separating direction E4, opposite the approaching direction E3. The CPU 41 uses the reader moving member 9 to change the distance between the platen 5 and reader 8 in the approaching direction E3 (S5) during the execution period of the inward-conveyance reading process. The inward-conveyance reading process executed by the CPU 41 of the printing device 1 helps to change the distance in the approaching direction E3 between the platen 5 and the reader 8 using the reader moving member 9 during the execution period of the inward-conveyance reading process. Thus, even when the thickness of the medium M in the area being read by the reader 8 varies during the execution period of the inward-conveyance reading process, the printing device 1 can change the distance between the platen 5 and the reader 8 in the approaching direction E3 to help maintain a suitable distance between the reader 8 and the target surface N.

The CPU 41 executes the inward-conveyance defect detection process (S9) to detect defects in the printing surface based on the inward-conveyance scan data. The inward-conveyance defect detection process executed by the CPU 41 of the printing device 1 helps to detect printing surface defects, which are different from nozzle ejection defects, based on the inward-conveyance scan data.

The CPU 41 executes the outward-conveyance defect detection process (S17) to detect printing defects based on the outward-conveyance scan data. The outward-conveyance defect detection process executed by the CPU 41 of the printing device 1 helps to detect printing defects on the medium M based on the outward-conveyance scan data. The CPU 41 of the printing device 1 helps to detect both printing surface defects and printing defects on the medium M, without having to add a separate reader 8 for detecting printing surface defects.

The printing device 1 includes the reader moving member 9, which is configured to move the reader 8 in the approaching direction E3 for approaching the platen 5 and in the separating direction E4, opposite the approaching direction E3. The CPU 41 executes an inward-conveyance reading process (S2, S3) with the reader 8 moved farther in the approaching direction E3 by the reader moving member 9 than the position of the reader 8 during an outward-conveyance reading process. The inward-conveyance reading process executed by the CPU 41 of the printing device 1 helps to reduce the likelihood of lint and other foreign matter intruding in between the reader 8 and the target surface N better than if the inward-conveyance reading process were executed with the reader 8 at a position other than the proximity position V. On the other hand, the outward-conveyance reading process is executed after executing the separating process (S8). The outward-conveyance reading process executed by the CPU 41 of the printing device 1 helps to reduce the likelihood of contamination of the printed image and contamination of the reader 8 as a result of the reader 8 contacting the printed target surface N.

The printing device 1 includes the reader moving member 9, which is configured to move the reader 8 in the approaching direction E3 to approach the platen 5 and in the separating direction E4, opposite the approaching direction E3. The reader 8 is a contact image sensor, and the target surface N falls within the depth of field of the reader 8 in the direction perpendicular to the platen 5 (i.e., the range in which the target surface N is in focus) when the reader 8 is placed at the proximity position V close to the target surface N. The CPU 41 executes the approaching process (S2) for moving the reader 8 in the approaching direction E3 to the proximity position V. After the approaching process, the CPU 41 executes the inward-conveyance reading process (S3) with the reader 8 placed in the proximity position V. The printing surface defects may be detected even when the outward-conveyance scan data used for detecting printing defects is not as sharply in focus as during detecting printing surface defects. However, the inward-conveyance scan data used for detecting printing surface defects suitably represents an image in focus in this example, since this data is used to detect fine lint, and fabric grain. The printing device 1 helps detect defects by using scan data in suitable focus for the type of defects being detected. The approaching process executed by the CPU 41 of the printing device 1 helps to reduce the likelihood of lint and other foreign matter intruding between the reader 8 and the target surface N better than if the inward-conveyance reading process were executed with the reader 8 at a position other than the proximity position V.

The printing device 1 has the contact sensor 18 for detecting whether the reader 8 has contacted the target surface N. The proximity position V is the position at which the reader 8 is in contact with the target surface N. In the approaching process of S2, the CPU 41 moves the reader 8 to the proximity position V in the approaching direction E3 based on detection results from the contact sensor 18. Following the approaching process, the CPU 41 executes the inward-conveyance reading process (S3) while the reader 8 is in contact with the target surface N. The approaching process executed by the CPU 41 of the printing device 1 contributes to the execution of the inward-conveyance reading process while the reader 8 is maintained in contact with the target surface N. The approaching process executed by the CPU 41 of the printing device 1 helps to reduce the likelihood of lint and other foreign matter intruding between the reader 8 and the target surface N.

Following the inward-conveyance reading process, the CPU 41 executes the separating process to move the reader 8 in the separating direction E4 opposite the approaching direction E3 (S8). Since the reader 8 is in contact with the target surface N of the medium M during the inward-conveyance reading process, the separating process executed by the CPU 41 of the printing device 1 helps to reduce the likelihood of contact between the reader 8 and the printed target surface N while the platen 5, which supports the printed medium M, is moved in the outward conveying direction E2.

After at least starting the separating process, the CPU 41 executes the outward-conveyance reading process (S15) while the reader 8 is separated farther from the target surface N than when executing the inward-conveyance reading process. The separating process executed by the CPU 41 of the printing device 1 contributes to the execution of the outward-conveyance reading process performed while the reader 8 is separated from the target surface N. The separating process executed by the CPU 41 of the printing device 1 helps to reduce the likelihood of contamination of the printed image and contamination of the reader 8 as a result of the reader 8 contacting the printed target surface N.

The printing device 1 includes the platen 5, the print heads 3 and 4, the platen moving member 6, the display 28, and the CPU 41. The print heads 3 and 4 are configured to print an image on the target surface N of a medium M placed on the platen 5. The reader 8 is configured to read the target surface N of the medium M. The platen moving member 6 is configured to move the platen 5 in each of the inward conveying direction E1 and the outward conveying direction E2, opposite the inward conveying direction E1. The reader 8 is disposed upstream of the print heads 3 and 4 in the inward conveying direction E1. The CPU 41 executes the inward-conveyance reading process (S3) to obtain inward-conveyance scan data with the reader 8 reading the target surface N of the unprinted medium M supported on the platen 5, which is being moved in the inward conveying direction E1 by the platen moving member 6. After executing the inward-conveyance reading process, the CPU 41 performs a printing process (S13) to print images with the print heads 3 and 4 on the target surface N of the medium M placed on the platen 5, which is being moved in the outward conveying direction E2 by the platen moving member 6. After executing the inward-conveyance reading process, the CPU 41 executes an inward-conveyance notification process (S21) to report defects through the display 28. The inward-conveyance reading process executed by the CPU 41 of the printing device 1 contributes to obtaining inward-conveyance scan data obtained by reading the target surface N of the unprinted medium M and to reporting defects through the display 28. The inward-conveyance scan data obtained by the printing device 1 helps to detect defects other than nozzle ejection defects.

The CPU 41 executes the inward-conveyance defect detection process (S9) to detect printing surface defects based on the inward-conveyance scan data. In the inward-conveyance notification process (S21), the CPU 41 reports printing surface defects detected during the inward-conveyance defect detection process. The inward-conveyance defect detection process executed by the CPU 41 of the printing device 1 helps to detect printing surface defects based on inward-conveyance scan data obtained by reading the target surface N of the unprinted medium M and to report such defects through the display 28.

The CPU 41 executes the outward-conveyance reading process (S15) to obtain outward-conveyance scan data using the reader 8 to read the target surface N of the printed medium M supported on the platen 5, which is being moved in the outward conveying direction E2 by the platen moving member 6. The CPU 41 executes the outward-conveyance defect detection process (S17) to detect printing defects based on the outward-conveyance scan data. The CPU 41 executes the outward-conveyance notification process (S18) to report printing defects detected in the outward-conveyance defect detection process. The outward-conveyance defect detection process executed by the CPU 41 of the printing device 1 helps to detect printing defects based on the outward-conveyance scan data obtained by reading the target surface N of the printed medium M and to report these printing defects through the display 28.

The printing device 1 includes the reader moving member 9, which is configured to move the reader 8 in the approaching direction E3 to approach the platen 5 and in the separating direction E4, opposite the approaching direction E3. The CPU 41 executes the approaching process (S2) to move the reader 8 in the approaching direction E3 in order to bring the reader 8 near the target surface N. Following the approaching process, the CPU 41 executes the inward-conveyance reading process (S3) while the reader 8 is positioned near the target surface N. The approaching process executed by the CPU 41 of the printing device 1 contributes to the execution of the inward-conveyance reading process performed while the reader 8 is near the target surface N. The approaching process executed by the CPU 41 of the printing device 1 helps to reduce the likelihood of lint and other foreign matter intruding between the reader 8 and target surface N better than if the inward-conveyance reading process were executed without the reader 8 positioned near the target surface N.

Following the inward-conveyance reading process, the CPU 41 executes the separating process (S8) to move the reader 8 in the separating direction E4 opposite the approaching direction E3. After at least starting the separating process, the CPU 41 executes the outward-conveyance reading process (S15). The separating process executed by the CPU 41 of the printing device 1 contributes to the execution of the outward-conveyance reading process performed while the reader 8 is separated from the target surface N. The separating process executed by the CPU 41 of the printing device 1 helps to reduce the likelihood of contamination of the printed image and contamination of the reader 8 as a result of the reader 8 contacting the printed target surface N.

The printing device 1 includes the platen 5, the print heads 3 and 4, the reader 8, the platen moving member 6, and the CPU 41. The print heads 3 and 4 are configured to print an image on the target surface N of a medium M placed on the platen 5. The reader 8 is configured to read the target surface N of the medium M. The platen moving member 6 is configured to move the platen 5 in each of the inward conveying direction E1 and the outward conveying direction E2, opposite the inward conveying direction E1. The reader 8 is arranged upstream of the print heads 3 and 4 in the inward conveying direction E1. The CPU 41 executes the inward-conveyance reading process (S3) to obtain inward-conveyance scan data using the reader 8 to read the target surface N of a medium M placed on the platen 5, which is moved in the inward conveying direction E1 by the platen 5. After executing the inward-conveyance reading process, the CPU 41 executes the printing process (S13) for printing images with the print heads 3 and 4 on the target surface N of the medium M supported on the platen 5, which is conveyed in the outward conveying direction E2 by the platen moving member 6. The CPU 41 executes the inward-conveyance defect detection process (S9) to detect defects based on the inward-conveyance scan data. The printing device 1 obtains inward-conveyance scan data by reading the target surface N of the unprinted medium M and detects defects based on this inward-conveyance scan data. Therefore, the inward-conveyance scan data obtained by the printing device 1 helps in detecting defects other than nozzle ejection defects.

The CPU 41 executes the outward-conveyance reading process (S15) to obtain outward-conveyance scan data using the reader 8 to read the target surface N of the medium M placed on the platen 5, which is moved in the outward conveying direction E2 by the platen moving member 6. The CPU 41 executes the outward-conveyance defect detection process (S17) to detect defects based on the outward-conveyance scan data. The outward-conveyance defect detection process executed by the CPU 41 of the printing device 1 helps to detect printing defects based on outward-conveyance scan data obtained by reading the target surface N of the printed medium M.

The printing device 1 includes the reader moving member 9, which is configured to move the reader 8 in the approaching direction E3 to approach the platen 5, and in the separating direction E4 opposite the approaching direction E3. The CPU 41 executes the approaching process (S2) using the reader moving member 9 to move the reader 8 in the approaching direction E3 and bring the reader 8 near the target surface N. Following the approaching process, the CPU 41 executes the inward-conveyance reading process (S3) while the reader 8 is positioned near the target surface N. The approaching process executed by the CPU 41 of the printing device 1 contributes to the execution of the inward-conveyance reading process performed with the reader 8 near the target surface N. The approaching process executed by the CPU 41 of the printing device 1 helps to reduce the likelihood of lint and other foreign matter intruding between the reader 8 and the target surface N better than if the inward-conveyance reading process were executed without the reader 8 positioned near the target surface N.

Following the inward-conveyance reading process, the CPU 41 executes the separating process (S8) to move the reader 8 in the separating direction E4, opposite the approaching direction E3. After at least starting the separating process, the CPU 41 executes the outward-conveyance reading process (S15). The separating process executed by the CPU 41 of the printing device 1 contributes to the execution of the outward-conveyance reading process performed when the reader 8 is separated from the target surface N. The separating process executed by the CPU 41 of the printing device 1 helps to reduce the likelihood of contamination of the printed image and contamination of the reader 8 as a result of the reader 8 contacting the printed target surface N.

The reader 8 is a contact image sensor. A contact image sensor contributes to making the reader 8 of the printing device 1 more compact than if the reader 8 were configured of a CCD image sensor.

While the invention has been described in conjunction with various example structures outlined above and illustrated in the figures, various alternatives, modifications, variations, improvements, and substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and substantial equivalents. Some specific examples of potential alternatives, modifications, or variations in the described invention are described below:

The present disclosure may be implemented in various forms, such as a printing device control method, a printing device control program, and a non-transitory medium that stores the printing device control program. The variations described below and the above embodiment may be combined with each other as appropriate insofar as no inconsistencies arise.

The configuration of the printing device 1 may be modified as appropriate. For example, the printing device 1 in the above embodiment may be a type other than an inkjet printer, such as a laser printer. The number of print heads, such as the print head 3, and 4, may be one or three or more. The configurations of the platen moving member 6 and reader moving member 9 may both be modified, or the platen moving member 6 and reader moving member 9 may be eliminated. The reader moving member 9 may include a solenoid, for example, and may use the power of the solenoid to move the reader 8 in the approaching direction E3 and separating direction E4. The configuration of the input interface 29 may be changed to a touchscreen or other configuration as appropriate, or the input interface 29 may be omitted. When the input interface 29 is eliminated from the printing device 1, various instructions may be obtained from external devices. The display 28 may be any device capable of displaying images, such as an OLED display, a plasma display, a plasma tube array display, or an electronic paper display employing electrophoresis. The display 28 may also be omitted. When the display 28 is eliminated from the printing device 1, the process of reporting defect detection results may be performed through an audio outputting device such as a speaker, through a light-emitting device, such as one or more LED lamps, or by outputting the notification information to an external device to request the external device to report the defect detection results.

The arrangement and configuration of the reader 8 may be modified. The reader 8 may have a configuration other than a contact image sensor, such as a CCD image sensor. The reader 8 may be immovable in the separating direction E4 away from the platen 5 and the approaching direction E3 toward the platen 5 or may be manually movable in the separating direction E4 or approaching direction E3. The arrangement and configuration of the contact sensor 18 may be modified, or the contact sensor 18 may be omitted. The contact sensor 18 may be an optical sensor that optically detects whether the reader 8 has contacted the target surface N of the medium M. The inward conveying direction E1, outward conveying direction E2, approaching direction E3, and separating direction E4 may each be modified as appropriate in accordance with the configuration of the printing device 1.

The printing device control program that contains instructions for executing the main process of FIG. 5 may not be stored in the ROM but may be stored in an external storage. In this case, the printing device control program is obtained from the external storage for the CPU 41 to start the printing device control program. Therefore, the method and route for obtaining the printing device control program and the device that stores the printing device control program may be modified. For example, the printing device control program executed by the CPU 41 may be received from the external device via a cable or a wireless communication and stored in a storage such as the memory 44. The external device may be a personal computer or a server to which the printing device 1 can connect via a network.

While the CPU 41 executes each step of the main process in the above example, all or some of the steps may be executed by another electronic device (e.g., an application specific integrated circuit (ASIC)). Alternatively, steps in the main process may be executed through distributed processing performed by a single CPU, a plurality of CPUs, an application specific integrated circuit (ASIC) or other hardware, or a combination of these components. The term “processor” encompasses both a single processor or a group of multiple processors located either locally or remotely working together or in a distributed fashion to collectively perform the tasks attributed to the “processor” described herein. One or more processors may be referred to as a controller.

Steps may also be added to or omitted from the main process, and the order of the steps may be modified. The described below modifications may be incorporated in the main process as appropriate.

The CPU 41 may skip S2 and S8, and execute the inward-conveyance reading process with the reader 8 in the same position as during the outward-conveyance reading process.

The CPU 41 may also skip the inward-conveyance defect detection process of S9 and output the inward-conveyance scan data to an external device to request the external device to detect printing surface defects. In this case, the CPU 41 may obtain the detection results from the external device and report these detection results on the display 28. The CPU 41 may display an image represented by the inward-conveyance scan data on the display 28 and enables the user to visually determine whether the printing surface has any defects. Similarly, the CPU 41 may skip the outward-conveyance defect detection process of S17 and output the outward-conveyance scan data to the external device to request the external device to detect any printing defects. In this case, the CPU 41 may obtain the detection results from the external device and report these detection results on the display 28. The CPU 41 may display an image represented by the outward-conveyance scan data on the display 28 to enable the user to visually determine whether any printing defects are present.

The target surface N may be located outside the depth of field of the reader 8 in the direction perpendicular to the platen 5 (i.e., may not be in sharp focus) when the reader 8 is disposed at the proximity position V close to the target surface N. The CPU 41 may not use the detection results of the contact sensor 18 when moving the reader 8 in the approaching direction E3 during the approaching process of S2. The CPU 41 may skip the separating process of S8 following the inward-conveyance reading process. The timing for executing the separating process may be modified, and the separating process may be executed while the platen 5 is being moved in the outward conveying direction E2.

The CPU 41 may skip the outward-conveyance reading process of S15. The CPU 41 may skip the outward-conveyance notification process of S18. The CPU 41 may output detection results for printing surface defects to an external device to enable the external device to report the detection results. Similarly, the CPU 41 may skip the inward-conveyance notification process of S21. The CPU 41 may output detection results for printing defects to the external device to enable the external device to report the detection results. The CPU 41 may execute the printing process while the platen 5 is being conveyed in the inward conveying direction E1 from the mounting/removing position P to the reversing position R. In this case, the printing process may be executed in parallel with the inward-conveyance reading process or may be executed after completing the inward-conveyance reading process.

What is claimed is:

1. A printing device comprising:
a platen;
a print head;
a reader positioned upstream of the print head in a first moving direction;
a platen moving member; and
a controller comprising one or more processors, the controller being configured to perform:
a first reading process including:
moving, by controlling the platen moving member, the platen in the first moving direction; and
reading, by controlling the reader, a surface of a printing target on the platen to obtain first scan data;
a printing process after starting the first reading process, the printing process including:
printing, by controlling the print head, an image on the surface of the printing target on the platen; and
a second reading process including:
moving, by controlling the platen moving member, the platen in a second moving direction opposite the first moving direction; and
reading, by controlling the reader, the image on the surface of the printing target on the platen to obtain second scan data.

2. The printing device according to claim 1, further comprising:
a reader moving member,
wherein the controller is configured to further perform:
moving, by controlling the reader moving member, the reader in such a manner that a distance between the reader and the platen during the first reading process is less than a distance between the reader and the platen during the second reading process.

3. The printing device according to claim 1, further comprising:
a reader moving member,
wherein the controller is configured to further perform:
adjusting, by controlling the reader moving member to move the reader during the first reading process, a distance between the reader and the platen.

4. The printing device according to claim 1,
wherein the controller is configured to further perform:
determining, based on the first scan data, whether the surface has a defect.

5. The printing device according to claim 4,
wherein the controller is configured to further perform:
determining, based on the second scan data, whether the image printed on the surface has a defect.

6. The printing device according to claim 5, further comprising:
a reader moving member,
wherein the controller is configured to further perform:
moving, by controlling the reader moving member, the reader in such a manner that a distance between the reader and the platen during the first reading process is less than a distance between the reader and the platen during the second reading process.

7. The printing device according to claim 1, further comprising:
a reader moving member,
wherein the reader is a contact image sensor,
wherein the controller is configured to further perform:
an approaching process before starting the reading the surface of the printing target on the platen, the approaching process including:
moving, by controlling the reader moving member, the contact image sensor toward the platen to reach an in-focus position at which the surface falls within a depth of field of the contact image sensor,
wherein in the first reading process the contact image sensor at the in-focus position reads the surface of the printing target on the platen.

8. The printing device according to claim 7, further comprising:
a contact sensor,
wherein the contact image sensor at the in-focus position is in contact with the surface of the printing target on the platen,
wherein the approaching process is performed based on detection data outputted from the contact sensor, the detection data indicating whether the contact image sensor is in contact with the surface.

9. The printing device according to claim 7,
wherein the controller is configured to further perform:
a receding process after completing the first reading process, the receding process including:
moving, by controlling the reader moving member, the contact image sensor away from the platen.

10. The printing device according to claim 9,
wherein the controller is configured to further perform:
moving, by controlling the reader moving member, the contact image sensor in such a manner that a distance between the contact image sensor and the platen during the second reading process exceeds a distance between the contact image sensor and the platen during the first reading process.

11. The printing device according to claim 1,
wherein the reader is a contact image sensor.

12. A printing device comprising:
a platen;
a print head;
a reader positioned upstream of the print head in a first moving direction;
a platen moving member; and
a controller comprising one or more processors, the controller being configured to perform:
a first reading process including:
moving, by controlling the platen moving member, the platen in the first moving direction; and
reading, by controlling the reader, a surface of a printing target on the platen to obtain first scan data;
a printing process after starting the first reading process, the printing process including:
printing, by controlling the print head, an image on the surface of the printing target on the platen; and
a first information providing process after completing the first reading process, the first information providing process including:
providing information based on the first scan data.

13. The printing device according to claim 12,
wherein the controller is configured to further perform:
detecting, before starting the first information providing process, a defect of the surface based on the first scan data,
wherein when the defect of the surface is detected, the information provided in the first information providing process includes information regarding the defect of the surface.

14. The printing device according to claim 13,
wherein the controller is configured to further perform:
a second reading process including:
moving, by controlling the platen moving member, the platen in a second moving direction opposite the first moving direction; and
reading, by controlling the reader, the image on the surface of the printing target on the platen to obtain second scan data; and
detecting a defect of the image printed on the surface based on the second scan data; and
a second information providing process including:
providing information based on the second scan data,
wherein when the defect of the image is detected, the information provided in the second information providing process includes information regarding the defect of the image.

15. The printing device according to claim 14, further comprising:
a reader moving member,
wherein the controller is configured to further perform:
an approaching process before starting the reading the surface of the printing target on the platen, the approaching process including:
moving, by controlling the reader moving member, the reader toward the platen to reach an approaching position,
wherein in the first reading process the reader at the approaching position reads the surface of the printing target on the platen.

16. The printing device according to claim 15,
wherein the controller is configured to further perform:
a receding process after completing the first reading process, the receding process including:
moving, by controlling the reader moving member, the reader away from the platen,
wherein the second reading process is performed after the receding process is started.

17. A printing device comprising:
a platen;
a print head;
a reader positioned upstream of the print head in a first moving direction;
a platen moving member; and
a controller comprising one or more processors, the controller being configured to perform:
a first reading process including:
moving, by controlling the platen moving member, the platen in the first moving direction; and
reading, by controlling the reader, a surface of a printing target on the platen to obtain first scan data;
a printing process after starting the first reading process, the printing process including:
printing, by controlling the print head, an image on the surface of the printing target on the platen; and
a first determining process including:
determining, based on the first scan data, whether the surface has a defect.

18. The printing device according to claim 17,
wherein the controller is configured to further perform:
a second reading process including:
moving, by controlling the platen moving member, the platen in a second moving direction opposite the first moving direction; and
reading, by controlling the reader, the image on the surface of the printing target on the platen to obtain second scan data;
a second determining process including:
determining, based on the second scan data, whether the image printed on the surface has a defect; and
a notification process including:
issuing a notification related to the defect of the image.

19. The printing device according to claim 18, further comprising:
a reader moving member,
wherein the controller is configured to further perform:
an approaching process before starting the reading the surface of the printing target on the platen, the approaching process including:
moving, by controlling the reader moving member, the reader toward the platen to reach an approaching position,
wherein in the first reading process the reader at the approaching position reads the surface of the printing target on the platen.

20. The printing device according to claim 19,
wherein the controller is configured to further perform:
a receding process after completing the first reading process, the receding process including:
moving, by controlling the reader moving member, the reader away from the platen,
wherein the second reading process is performed after the receding process is started.
